(19) United States
(12) Patent Application Publication
(10) Pub. No.: US 2026/0046052 A1
(43) Pub. Date: Feb. 12, 2026

(54) METHOD AND APPARATUS FOR TRANSMITTING AND RECEIVING SENSING SIGNAL IN NR SYSTEM

(71) Applicant: ELECTRONICS AND TELECOMMUNICATIONS RESEARCH INSTITUTE, Daejeon (KR)

(72) Inventors: Kwang Jae LIM, Daejeon (KR); Hyoung Soo LIM, Daejeon (KR)

(73) Assignee: ELECTRONICS AND TELECOMMUNICATIONS RESEARCH INSTITUTE, Daejeon (KR)

(21) Appl. No.: 19/288,814

(22) Filed: Aug. 1, 2025

(30) Foreign Application Priority Data
Aug. 9, 2024 (KR) 10-2024-0106569

(51) Int. Cl. H04J 13/00; H04L 27/26; H04W 72/231; H04W 76/20

(52) U.S. Cl. CPC H04J 13/0062; H04L 27/2605; H04W 72/231; H04W 76/20

(57) ABSTRACT

According to an aspect of the present disclosure, provided is a method for transmitting and receiving a sensing signal in a new radio (NR) system, including: spreading a Zadoff-chu (ZC) code sequence into an orthogonal code in a transmitting device to generate a sensing code sequence; generating a sensing OFDM symbol by performing an OFDM (Orthogonal Frequency Division Multiplexing) transform on the sensing code sequence; and transmitting a communication symbol and the sensing OFDM symbol through a plurality of antennas. Embodiments of the present disclosure may generate and transmit a sensing signal for sensing an surrounding object and an environment, and efficiently reduce interference between sensing OFDM symbols when receiving the sensing signal.

### CROSS-REFERENCE TO RELATED APPLICATION

The present application claims priority to Patent Application No. 10-2024-0106569, filed on in Korea Intellectual Property Office on Aug. 9, 2024, the entire contents of which are incorporated herein by reference.

### TECHNICAL FIELD

The present disclosure relates to a method and an apparatus for transmitting and receiving a sensing signal in an NR system.

### BACKGROUND

The content described below merely provides background information related to the present embodiment, and does not constitute the prior art.

Looking back on the development process of wireless communication generations, technologies mainly for human services such as voice, multimedia, and data have been developed. It is expected that connected devices, which have been explosively increasing since the commercialization of the 5th-generation (5G) communication system, will be connected to a communication network. Examples of objects connected to the network may include vehicles, robots, drones, home appliances, displays, smart sensors installed in various infrastructures, construction machinery, factory equipment, and the like. Mobile devices are expected to evolve into a variety of form factors, such as augmented reality glasses, virtual reality headsets, and holographic devices. In the 6th-generation (6G) era, efforts are being made to develop an improved 6G communication system in order to provide various services by connecting hundreds of billions of devices and objects. For this reason, a 6G communication system is referred to as a 5G communication beyond system.

As more and more communication devices require greater communication capacity, there is a need for improved mobile broadband communications over existing Radio Access Technology (RAT). Accordingly, a communication system considering a service or terminal sensitive to reliability and latency is discussed, and a next-generation radio access technology considering improved mobile broadband communication, massive machine type communication (MTC), ultra-reliable and low latency communication (URLLC), and the like may be referred to as a new radio access technology (RAT) or a new radio (NR).

In an NR system, an existing synchronization signal or reference signal, such as a primary synchronization signal (PSS), a secondary synchronization signal (SSS), a channel state information-reference signal (CSI-RS), a demodulation reference signal (DMRS), or a positioning reference signal (PRS), transmitted by a base station is not originally designed for sensing a surrounding object or an environment, and thus is unsuitable for efficient sensing.

### SUMMARY

The present disclosure provides a method and an apparatus for generating a sensing signal for sensing surrounding objects and an environment.

The present disclosure provides a method and an apparatus for receiving a sensing signal for sensing surrounding objects and an environment.

The present disclosure provides a method and an apparatus for efficiently reducing interference between sensing OFDM symbols when receiving a sensing signal.

The problems to be solved by the present invention are not limited to the above-mentioned problems, and other problems that are not mentioned will be clearly understood by those skilled in the art from the following description.

According to an aspect of the present disclosure, provided is a method for transmitting and receiving a sensing signal in a new radio (NR) system, including spreading a Zadoff-chu (ZC) code sequence into an orthogonal code in a transmitting device to generate a sensing code sequence; generating a sensing OFDM symbol by performing an OFDM (Orthogonal Frequency Division Multiplexing) transform on the sensing code sequence; and transmitting a communication symbol and the sensing OFDM symbol through a plurality of antennas.

An apparatus according to an embodiment of the present disclosure is an apparatus for transmitting and receiving a sensing signal in a new radio (NR) system, including a memory including instructions; and a processor configured to, in a transmitting device by executing the instruction, spread a Zadoff-chu (ZC) code sequence into an orthogonal code to generate a sensing code sequence, generate a sensing OFDM symbol by performing an OFDM (Orthogonal Frequency Division Multiplexing) transform on the sensing code sequence and transmit a communication symbol and the sensing OFDM symbol through a plurality of antennas.

The present disclosure may generate a sensing signal for sensing surrounding objects and an environment.

The present disclosure may receive a sensing signal for sensing surrounding objects and environments.

The present disclosure may efficiently reduce interference between sensing OFDM symbols when a sensing signal is received.

According to the present disclosure, it is possible to increase a success rate of sensing detection even when a specific symbol has a large self-interference.

The effects of the present disclosure are not limited to the above-mentioned effects, and other effects that are not mentioned will be clearly understood by those skilled in the art from the following description.

### BRIEF DESCRIPTION OF THE DRAWINGS

FIG. 1 illustrates an example in which an existing mobile communication service is extended to a service for sensing surrounding objects and an environment by using an NR system applied to an embodiment of the present disclosure.

FIG. 2 illustrates a method of configuring sensing OFDM symbols according to an embodiment of the present disclosure.

FIG. 3 is an exemplary diagram of a method for transmitting sensing OFDM symbols in an NR slot according to an embodiment of the present disclosure.

FIG. 4 is an exemplary diagram of transmission in different symbol sections between base stations to avoid interference between sensing OFDM symbols transmitted by various base stations according to an embodiment of the present disclosure.

FIG. 5 is an exemplary diagram illustrating a receiving operation when a base station receives a sensing OFDM symbol transmitted by the base station and senses a surrounding object or environment, according to an embodiment of the present disclosure.

FIG. 6 is an exemplary diagram illustrating a process of receiving a sensing signal in a base station according to another embodiment of the present disclosure.

FIG. 7 is an exemplary diagram of another process of transmitting and receiving sensing OFDM symbols according to another embodiment of the present disclosure.

FIG. 8 is an exemplary diagram of a transmission process of transmitting a sensing signal according to an embodiment of the present disclosure.

FIG. 9 is an exemplary diagram illustrating a process of receiving a sensing signal in a base station according to an embodiment of the present disclosure.

FIG. 10 is an exemplary diagram illustrating a case where a sensing signal is detected by a correlator in a time domain according to an embodiment of the present disclosure.

FIG. 11 is a flowchart of a method for transmitting a sensing signal in an NR system according to an embodiment of the present disclosure.

FIG. 12 is an exemplary diagram of a transmitting device for transmitting a sensing signal and a receiving device for detecting a sensing signal in an NR system according to an embodiment of the present disclosure.

FIG. 13 is a flowchart of a method for receiving a sensing signal in an NR system according to an embodiment of the present disclosure.

FIG. 14 is a block diagram schematically illustrating an example computing device to which the present disclosure may be applied.

### DETAILED DESCRIPTION

Hereinafter, some embodiments of the present disclosure will be described in detail with reference to the accompanying drawings. Note that when components in each drawing are denoted by reference numerals, the same components are denoted by the same numerals as much as possible even if they are denoted on different drawings. In addition, in describing the present disclosure, when it is determined that a specific description of a related known configuration or function may obscure the gist of the present disclosure, the detailed description thereof will be omitted.

In describing components of embodiments of the present disclosure, reference numerals such as first, second, i), ii), a), and b) may be used. These symbols are only used to distinguish the components from other components, and the nature, sequence, order, or the like of the components is not limited by the symbols. In the specification, when a part “includes” or “comprises” an element, unless there is an explicit description to the contrary, the part may further include other elements rather than excluding the other elements.

The detailed description set forth below in connection with the appended drawings is intended to describe exemplary embodiments of the disclosure and is not intended to represent the only embodiments in which the disclosure may be practiced.

The embodiment of the present disclosure is for sensing surrounding objects or an environment in an NR system, and although the NR communication network is described as a communication network, the communication network may be a 6G communication network, a new type of communication network, or the like, and is not limited to a specific type.

A terminal according to an embodiment of the present disclosure may be referred to as a user equipment (UE), a terminal, an access terminal, a mobile terminal, a station, a subscriber station, a mobile station, a portable subscriber station, node, device, or the like. Here, a desktop computer, a laptop computer, a tablet personal computer (PC), a wireless phone, a mobile phone, a smart phone, a smart watch, a smart glass, an e-book reader, a portable multimedia player (PMP), a portable game machine, a navigation device, a digital camera, a digital multimedia broadcasting (DMB) player, a digital audio recorder, a digital audio player, a digital picture recorder, a Digital picture player, a digital video recorder, and a digital video player that may communicate with a terminal may be used.

A base station according to an embodiment of the present disclosure may be referred to as a Node B, a base transceiver station (BTS), a radio base station, a radio transceiver, an access point, an access node, a road side unit (RSU), a digital unit (DU), a cloud digital unit (CDU), a radio remote head (RRH), a radio unit (RU), a transmission point (TP), a transmission and reception point (TRP), a relay node, or the like.

An embodiment of the present disclosure generates a sensing code sequence by spreading a Zadoff-Chu (ZC) code sequence with an orthogonal code for sensing surrounding objects or the environment in an NR system, generates a sensing OFDM symbol by performing OFDM transformation on the sensing code sequence, and transmits the sensing OFDM symbol through a plurality of antennas according to a predefined offset, period, and interval in an NR slot.

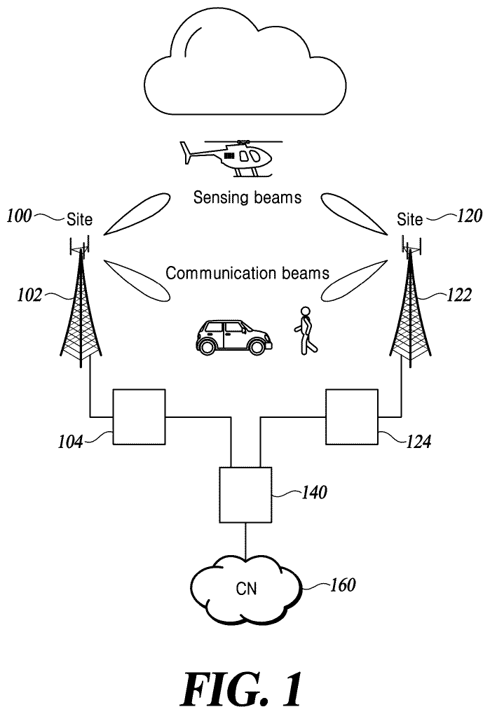

FIG. 1 illustrates an example in which an existing mobile communication service is extended to a service for sensing surrounding objects and an environment by using an NR system applied to an embodiment of the present disclosure.

Referring to FIG. 1, a first site 100 includes a first radio unit (RU) 102 and a first distributed unit (DU) 104.

Referring to FIG. 1, a second site 120 includes a second RU 122 and a second DU 124.

A CU 140 controls and manages the RUs 102 and 233 and the DUs 104 and 124 of each site, and connects to a core network (CN) 160.

The first site 100 and the second site 120 are configured to form sensing beams from an antenna array, transmit sensing signals through the beams, and detect an object or an environment by using reflected and received signals.

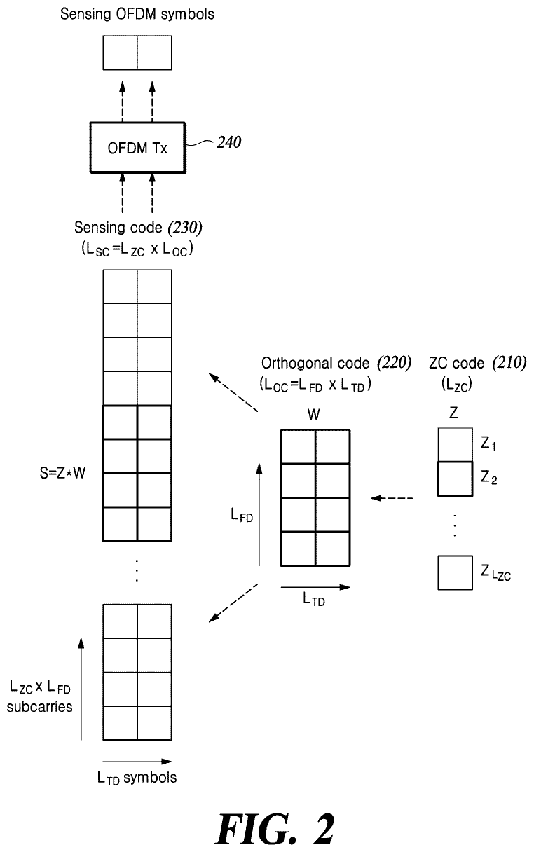

FIG. 2 illustrates a method of configuring sensing OFDM symbols according to an embodiment of the present disclosure.

A sensing code sequence 230 is generated by spreading a Zadoff-Chu (ZC) code sequence 210 unique to each cell with an orthogonal spreading code 220.

A sensing OFDM symbol is generated by OFDM converting the generated sensing code sequence 230 in the OFDM Tx 240. As shown in FIG. 2, two sensing OFDM symbols generated after the OFDM Tx 240 mean two sensing OFDM symbols generated in terms of time.

A ZC code sequence 210 of length L_{ZC} satisfies Equation 1.

$${z}_{q} ( k ) = e \hat{} ( - j * {q}^{′} * k * ( k + 1 ) / {L}_{ZC} ) , for k = 0 , 1 , … , {L}_{ZC} - 1 , and {q}^{′} = 1 , 2 , … , {L}_{ZC} - 2 \qquad ( Equation 1 )$$

For convenience, an underscore (_) is used to indicate a subscript and a caret (\hat{ }) to indicate a superscript, and the two notations may be used interchangeably throughout this specification.

In Equation 1, q is a base number for distinguishing a code sequence, and a length L_{ZC} is a prime number. Code sequences transmitted by different base stations are distinguished by using different base numbers q′. Since a code sequence generated by Equation 1 has an autocorrelation value of 0 at a non-zero offset, when signals with the same code are received with several delayed time differences, the received signals with different delays do not affect each other or generate only very small interference in the correlation process of the receiver. When a sequence having a length L′_{ZC} that is not a prime number is to be used, a ZC code sequence 210 of length L_{ZC}, which is a cyclic extension of the code sequence of Equation 1, satisfies Equation 2.

$${z}_{q}^{′} ( {k}^{′} ) = {z}_{q} ( {k}^{′} \% L ) , \qquad ( Equation 2 )$$

$${k}^{ ′} = 0 , 1 , … , {L}_{ZC}^{′} - 1$$

In Equation 2, % means a modulo operation.

The ZC code sequence thus generated is spread in terms of frequency (i.e., subcarriers) and time (i.e, symbols) with an orthogonal multiplexing code (hereinafter referred to as “orthogonal code”). The orthogonal code includes, but is not limited to, a Walsh Hadamard code or a Discrete Fourier Transform (DFT) code.

The DFT code sequence with the length L_{OC} satisfies Equation 3.

$${w}_{q} ( 1 ) = e \hat{} ( - j 2 π \cdot l \cdot q / {L}_{WC} ) , l = 0 , 1 , … , {L}_{OC} - 1 , q = 0 , 1 , … , {L}_{OC} - 1 \qquad ( Equation 3 )$$

Orthogonal codes having a length L_{OC} are orthogonal to each other. Therefore, by using L_{OC} code sequences orthogonal to each other, signals transmitted from N=L_{OC} antennas can be distinguished.

A Walsh-Hadamard code sequence of length L_{OC}=2ⁿ is a sequence consisting of one row in a matrix represented by mathematical expression 4.

$${w}_{q} ( l ) = \{ H\_ \{ {2}^{n} \{ ] \_ \{ q , l \} , l = 0 , 1 , … , {L}_{OC} - 1 , q = 0 , 1 , … , {L}_{OC} - 1 \qquad ( Equation 4 )$$

$${H}_{2 N} = [ \begin{matrix}{H}_{N} & {H}_{N} \\ {H}_{N} & - {H}_{N}\end{matrix} ] and$$

$${H}_{2} = [ \begin{matrix}1 & 1 \\ 1 & - 1\end{matrix} ]$$

An orthogonal code sequence having a length L_{OC} is of a length L_{FD} in a frequency domain (i.e., subcarriers) and having a length L_{TD} in a time domain (i.e., symbol) may be expressed by a matrix having the following Equation 5.

$$\begin{matrix}{w}_{q} ( l ) = [ \begin{matrix}{w}_{q} ( 0 ) & ⋯ & w\_q ( {L}_{FD} ( {L}_{TD} - 1 ) - 1 ) \\ ⋮ & ⋱ & ⋮ \\ {w}_{q} ( {L}_{FD} - 1 ) & ⋯ & w\_q ( {L}_{FD} * {L}_{TD} - 1 )\end{matrix} ] \\ = [ \begin{matrix}{w}_{q , 0} & ⋯ & {w}_{q , {L}_{TD} - 1} ]\end{matrix}\end{matrix} \qquad ( Equation 5 )$$

In order to generate the t(=0, . . . , L_{TD}−1)th sensing OFDM symbol in terms of time, the sensing code sequence S_{q′, q, t} of length L_{ZC} L_{FD} in a frequency domain is obtained from the ZC sequence Z_{q′} of length L_{ZC} of Equation 1 and the sequence w_{q,t} of length L_{FD} corresponding to the t-th column of the matrix of equation 5 as in Equation 6.

$${s}_{q , q , t}^{′} ( f ) = {z}_{q}^{′} ( k ) ⊗ {w}_{q , t} ( {l}_{f} ) , \qquad ( Equation 6 )$$

$$f = 0 , 1 , … , {L}_{ZC} {L}_{FD} - 1 ,$$

$$k = 0 , 1 , … , {L}_{ZC} - 1 ,$$

$${l}_{f} = 0 , 1 , … , {L}_{FD} - 1$$

In Equation 6, ⊗ represents a Kronecker product. Generated sensing code sequence S_{q′,q,t} generates a t-th sensing OFDM symbol for a q-th antenna by an OFDM symbol generation process including an inverse fast Fourier transform (IFFT) and a cyclic prefix (CP) addition process. Here, the process of adding a cyclic prefix (CP) refers to a process of transmitting an OFDM signal with a guard section such as a cyclic prefix prefixing a tail portion of the OFDM signal in order to overcome the influence of an inter-symbol interference (ISI).

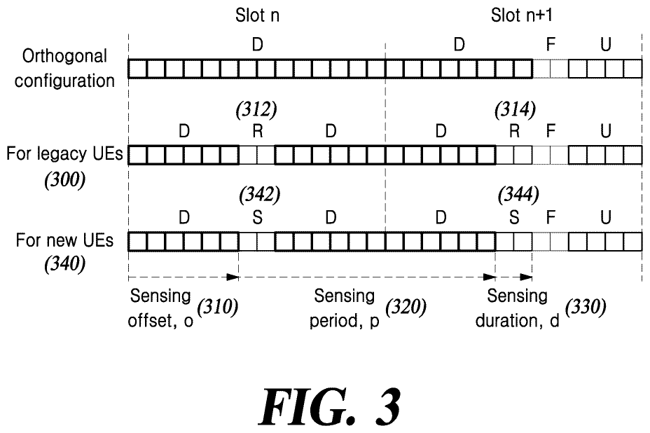

FIG. 3 is an exemplary diagram of a method for transmitting sensing OFDM symbols in an NR slot according to an embodiment of the present disclosure.

Referring to FIG. 3, D denotes a downlink (DL) OFDM symbol for a communication service, U denotes an uplink (UL) symbol, and F denotes an empty symbol period for switching between DL and UL.

Referring to FIG. 3, R 312 and R 314 represent reserved resources. S 342 and 344 denotes a sensing OFDM symbol, and a base station replaces a specific symbol in a slot with the sensing OFDM symbol S for sensing and transmits the symbol.

Since a legacy terminal 300 is not aware of the added sensing service function, the legacy terminal 300 does not detect the added sensing OFDM symbol. To this end, the period in which the sensing OFDM symbol is transmitted is specified as R 312 and R314, so that the existing terminal does not receive the symbol.

The base station may detect an object and an environment around the base station by receiving a signal obtained by reflecting the sensing OFDM symbol transmitted by the base station to an object and an environment (mono-static sensing). In addition, the terminal 340 supporting a sensing service may detect an object and an environment around the terminal by receiving a sensing OFDM symbol transmitted by a base station (bi-static sensing).

The base station specifies a position at which a sensing OFDM symbol is transmitted in NR slots by an offset 310, a period 320, and a duration 330 through a Radio Resource Control (RRC) message. The base station may notify transmission and stop of the sensing OFDM symbol through a Medium Access Control Control Element (MAC CE), and may notify transmission of the one-time sensing OFDM symbol using a specific Physical Downlink Control Channel (PDCCH) Downlink Control Information (DCI).

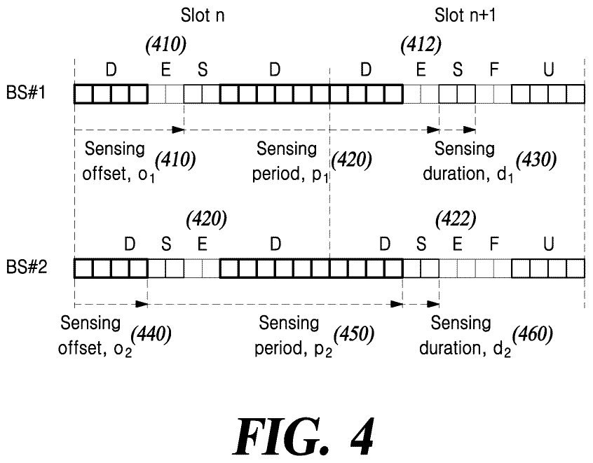

FIG. 4 is an exemplary diagram of transmission in different symbol sections between base stations to avoid interference between sensing OFDM symbols transmitted by various base stations according to an embodiment of the present disclosure.

Each base station transmits a sensing OFDM symbol in a symbol period that does not overlap with another base station according to its offset 410, 440, period 420, 450, and period 430, 460. In addition, by not transmitting any symbol in a section in which another base station transmits a sensing OFDM symbol, each base station may avoid interference.

In FIGS. 4, E 410, 412, 420 and 422 denotes an empty symbol period for interference avoidance. By providing E 410, 412, 420, and 422, a signal received by reflecting a sensing signal of a corresponding base station may be detected without interference of a signal transmitted by another base station, and sensing performance may be improved.

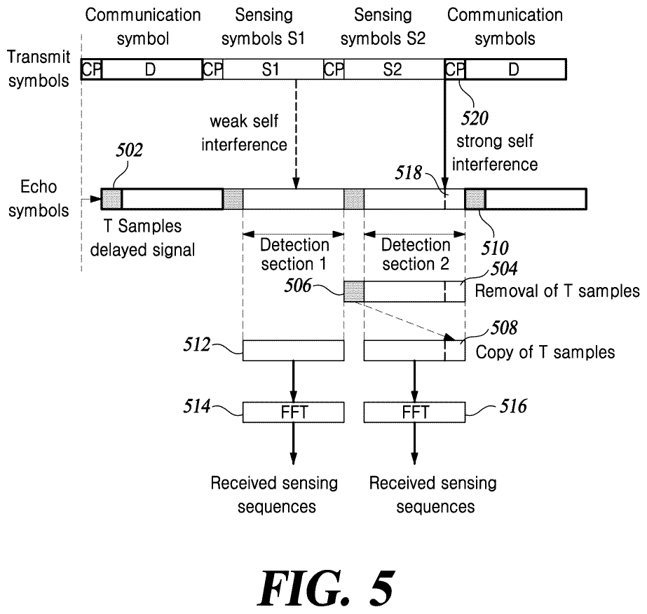

FIG. 5 is an exemplary diagram illustrating a receiving operation when a base station receives a sensing OFDM symbol transmitted by the base station and senses a surrounding object or environment, according to an embodiment of the present disclosure.

Referring to FIG. 5, a transmit symbol represents a transmission section for transmitting a communication symbol and a sensing OFDM symbol, and an echo symbol represents a reception section for receiving the communication symbol and the sensing OFDM symbol. The communication symbol refers to a symbol for providing a general communication service, and the sensing OFDM symbol refers to a symbol for sensing a surrounding object or an environment.

Referring to FIG. 5, it is assumed that the first communication symbol is followed by a second communication symbol, and the second communication symbol is a very strong signal and acts as interference.

Since the base station needs to transmit the communication symbols and the sensing OFDM symbols in the NR slot and receive the sensing OFDM symbols at the same time, the second communication symbols (reference numeral 520) transmitted at the same time to the receiver receiving the sensing OFDM Symbols acts as a very large interference.

In an embodiment of the present disclosure, a ZC code sequence is used to reduce such self-interference. Since the ZC code sequence has a very small correlation value with respect to different time-delayed signals, when a sensing OFDM symbol that has been reflected at the same time as transmitting the sensing OFDM symbol is received, interference from a currently transmitting sensing OFDM symbol may be very small.

For example, reception processes such as reference numerals 512 and 514 correspond to a case where a process of receiving the last sensing OFDM symbol is not considered, and in this case, a probability of successful sensing detection is low due to very large self-interference of a communication symbol (reference numeral 520).

However, the process of receiving the last sensing OFDM symbol is as follows.

In a case of a process of receiving the last sensing OFDM symbol (in a case of considering the process of receiving the final sensing OFDM symbol), as shown in FIG. 5, the sensing OFDM symbol is overlapped with a time of transmitting another communication symbol in a partial last-part section of the receiving section. Since the communication symbols are transmitted by any modulation symbol and precoding, it is not possible to expect a very small correlation characteristic by the ZC code sequence, such as when receiving sensing OFDM symbols. Therefore, in the embodiment of the present disclosure, when T-sample delayed signal 502 is detected, last-part T samples 518 and 504 of the last sensing OFDM symbol detection period are removed, and T samples 506 and 508 are copied from the beginning of the CP period in the last sensing OFMN symbol detection period to obtain the FFT length (T_{FFT}), and fast Fourier transform (FFT) 516 is performed from these samples. The FFT 516 then outputs the received sensing code sequences.

According to this process, it is possible to avoid a case in which the sensing signal information corresponding to the last-part T section of the receiving section may not be used, but the sensing detection fails due to very large self-interference caused by the communication symbol in the last-part T sample section. The foregoing description illustrates a case where the CP section 520 is greater than the reference numerals 518 and 502.

On the other hand, when detecting a T>T_{CP} sample delayed signal longer than the CP section length, only the last-part T_{CP} samples of the last sensed OFDM symbol detection section are removed, and the CP section samples of the last sensed OFMN symbol detection section are copied to generate samples corresponding to the FFT length T_{FFT} to perform FFT. In this case, in the latter part of the last sensing OFDM symbol, (T-T_{CP}) may be subject to self-interference by the communication symbol.

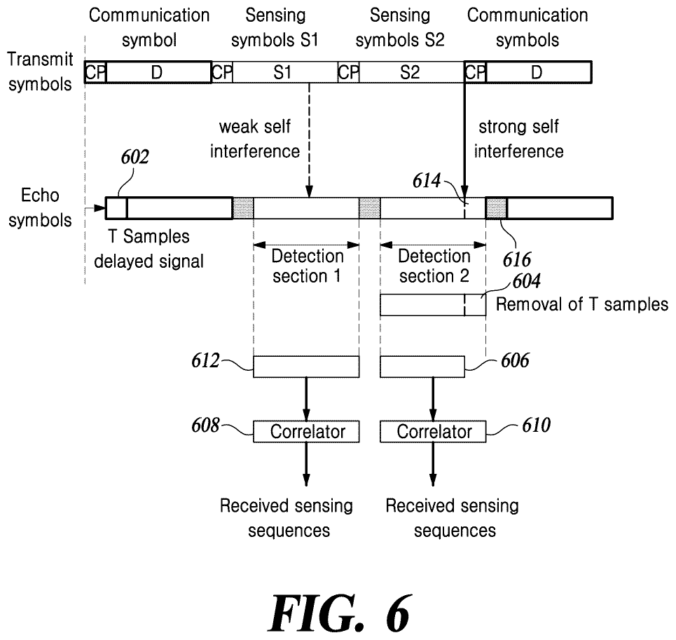

FIG. 6 is an exemplary diagram illustrating a process of receiving a sensing signal in a base station according to another embodiment of the present disclosure.

FIG. 6 illustrates another sensing signal detection method in which a sensing signal is detected by a correlator 610 in a time domain.

Referring to FIG. 6, a transmit symbol represents a transmission section for transmitting a communication symbol and a sensing OFDM symbol, and an echo symbol represents a reception section for receiving the communication symbol and the sensing OFDM symbol.

For example, reception processes such as reference numerals 612 and 614 correspond to a case in which a process of receiving a last sensing OFDM symbol is not considered, and in this case, a probability of successful sensing detection is low due to very large self-interference of a communication symbol (reference numeral 616).

However, the process of receiving the last sensing OFDM symbol is as follows.

Instead of a method of detecting the sensing signal in the frequency domain after FFT, a sensing signal may be detected by a correlator 610 in the time domain. Similarly in this case, when detecting a T sample delayed signal 602, last-part T samples 614 and 604 interfered by the communication symbol in the last sensing OFMN symbol detection section are removed, and only a length (T_{FFT}-T) sample 606 is used as the input to a correlator 610. Then, the correlator 610 performs correlation on only the length (T_{FFT}-T) samples 606 and outputs the received sensing code sequences.

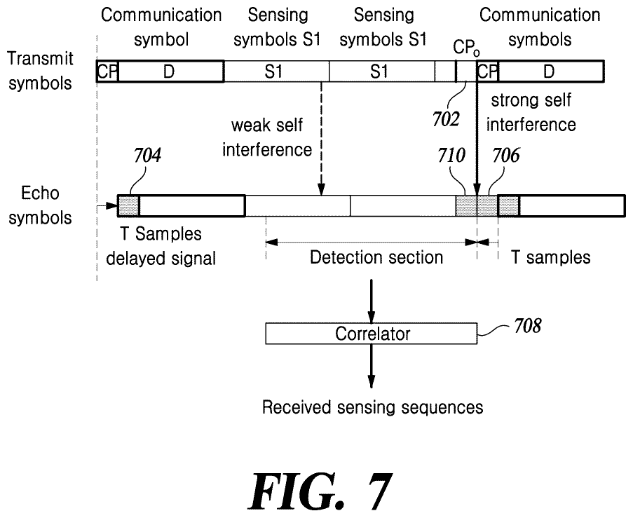

FIG. 7 is an exemplary diagram of another process of transmitting and receiving sensing OFDM symbols according to another embodiment of the present disclosure.

Referring to FIG. 7, a transmit symbol represents a transmission section for transmitting a communication symbol and a sensing OFDM symbol, and an echo symbol represents a reception section for receiving the communication symbol and the sensing OFDM symbol.

When a sensing OFDM symbol is formed, instead of spreading by an orthogonal spreading code in the time domain, a sensing code sequence is repeatedly transmitted, and a cyclic postfix (CP₀) 702 is added to the remaining section at the end.

The orthogonal code sequence of equation 5 has a length LED in terms of frequency and length L_{TD}=1 in terms of time. After performing IFFT on the first sensing code sequence S_{q′,q,t}=0 generated by Equation 6, the obtained sequence is repeatedly transmitted in the sensing OFDM symbol transmission section, and the CP₀ 702 is added to the remaining section at the end and transmitted. In the case of a receiving process, in order to avoid a section where the sensing OFDM symbol is interfered with by transmission of another communication symbol in a part of the last-part section of the receiving section, when a T-sample delayed signal 704 is detected, the samples detected in the detecting section are used as inputs of the receiving correlator 708, except for T-samples 706 in the last-part of the receiving section. In other words, when the T sample delayed signal 704 is detected, the sensing OFDM symbol is excluded from the T samples 706 at the last of the receiving section corresponding to the CP, and the samples detected in the detecting section (including the T samples 710 corresponding to the CP₀ 702) are used as inputs of a receiving correlator 708.

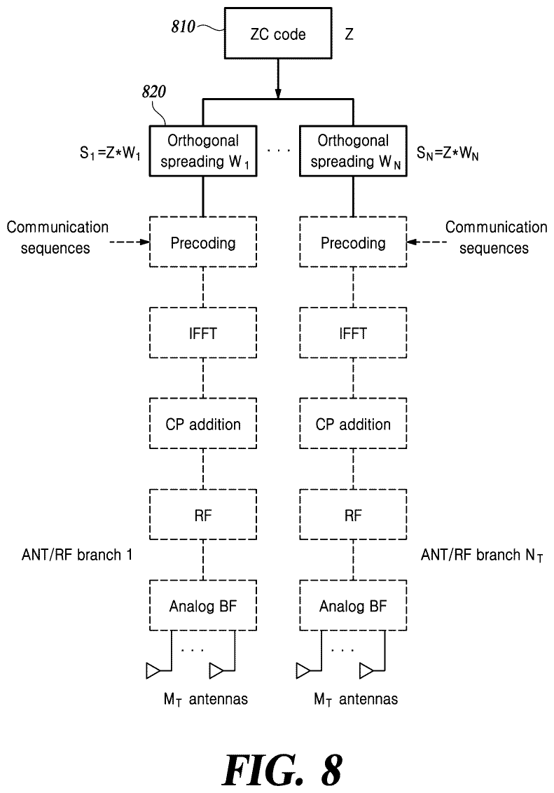

FIG. 8 is an exemplary diagram of a transmission process of transmitting a sensing signal according to an embodiment of the present disclosure.

A block indicated by a dotted line in FIG. 8 represents an existing transmission process for an existing communication service, and a block indicated by a solid line represents a process added to transmit a sensing OFDM symbol according to an embodiment of the present disclosure.

Reference numeral 810 includes a process of generating a ZC code sequence for sensing OFDM symbol transmission.

Reference numeral 820 includes a process of spreading the ZC code sequence into orthogonal codes that are orthogonal to each other for each of the N_{T} ANT/RF branches. That is, the length and the number of the orthogonal codes are L_{OC}=N_{T}. Then, a sensing code sequence is pre-coded for digital beamforming, and an OFDM symbol is generated through an OFDM symbol configuration process (IFFT process, CP addition process), and the generated sensing OFDM symbol is subjected to an RF process and are transmitted through MT antennas for each branch by analog beamforming.

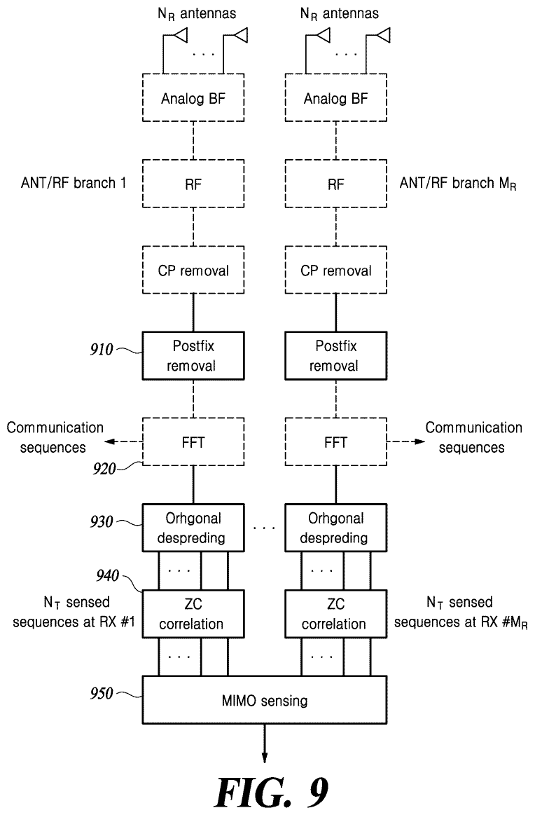

FIG. 9 is an exemplary diagram illustrating a process of receiving a sensing signal in a base station according to an embodiment of the present disclosure.

A block indicated by a dotted line in FIG. 9 represents an existing reception process for an existing communication service, and a block indicated by a solid line represents a process added to receive a sensing OFDM symbol according to an embodiment of the present disclosure.

In order for a base station to simultaneously receive a sensing signal at a transmission time of a communication/sensing signal, a method of eliminating self-interference due to a transmission signal is required. For this purpose, generally, a distance is set between a sensing signal receiving antenna and a transmitting antenna, and a process of installing an RF wall, self-interference cancellation filtering, and the like is additionally required. However, this departs from the gist of the present invention and is therefore omitted.

After the NR analog receiving beamforming process, the RF receiving process, and the CP removing process are performed on the signals received through the a plurality of antennas, the self-interference removing process by the communication symbols described in FIG. 5 to FIG. 7 is added when the last sensing OFDM symbol is received.

When the CP₀ 702 is added in the transmission process as in the case of FIG. 7, a Postfix removal process 910 is required in the reception process as shown in FIG. 9.

Then, N_{T} reception sensing code sequences are output for each of M_{R} reception ANT/RF branches through an FFT process 920, a despreading process 930 with orthogonal codes, a ZC code sequence correlation process 940, and a MIMO sensing process 950 are performed. The despreading process 930 by orthogonal codes includes the process of separating the received sensing signal into signals corresponding to N_{T} transmitting ANT/RF branches. Accordingly, when sensing OFDM symbols are transmitted from N_{T} transmitting ANT/RF branches and received from M_{R} receiving ANT/RF branches, sensing signals for a total of N_{T} M_{R} transmitting and receiving ANT/RF branch pairs are detected. The sensing signal reception processing process for detecting surrounding objects and the environment based on this is omitted as it deviates from the gist of the present invention.

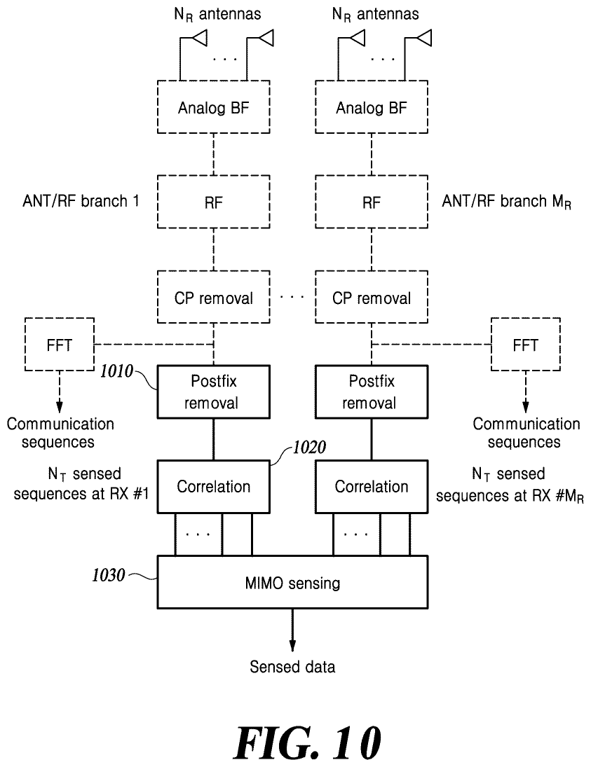

FIG. 10 is an exemplary diagram illustrating a case where a sensing signal is detected by a correlator in a time domain according to an embodiment of the present disclosure. In this case, the correlator performs correlation on N_{T} transmission signals for each receiving ANT/RF branch.

A block indicated by a dotted line in FIG. 10 represents an existing reception process for an existing communication service, and a block indicated by a solid line represents a process added to receive a sensing OFDM symbol according to an embodiment of the present disclosure.

Referring to FIG. 9 and FIG. 10, postfix elimination processes 910 and 1010 for self-interference elimination are described in a process of receiving, by a terminal, a sensing OFDM symbol transmitted by a base station, but a postfix elimination process for self-intervention elimination may not be required.

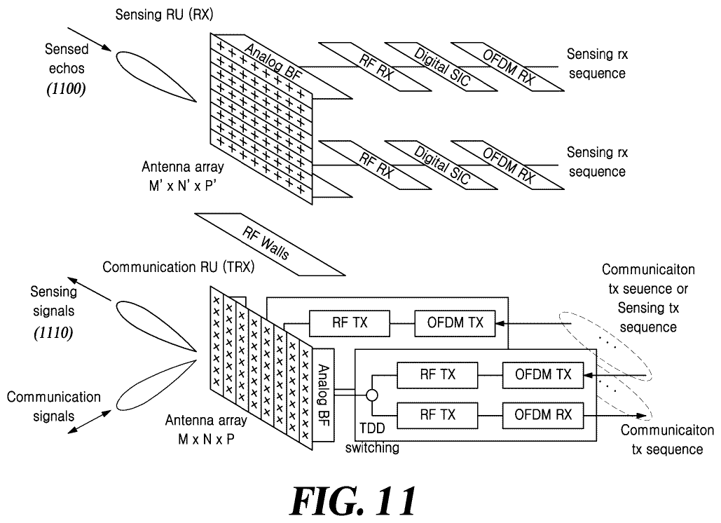

FIG. 11 is a flowchart of a method for transmitting a sensing signal in an NR system according to an embodiment of the present disclosure.

Reference numeral 1100 denotes a process of receiving a sensed echoes signal in a receiving device. The receiving device performs the operations in FIG. 5, FIG. 6, FIG. 7, FIG. 9, and FIG. 10 described above.

Reference numeral 1110 denotes a process of transmitting sensing signals and communication signals in a transmitting device. The transmitting device performs the operations in FIG. 2, FIG. 3, FIG. 4, and FIG. 8 described above.

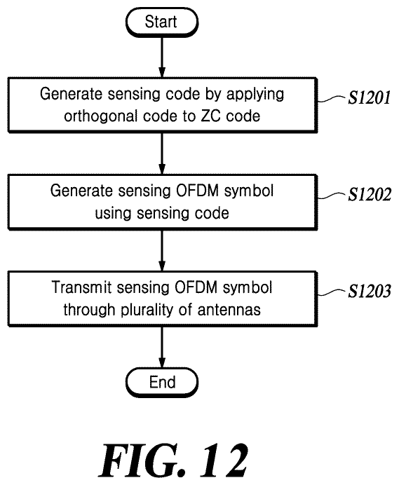

FIG. 12 is an exemplary diagram of a transmitting device for transmitting a sensing signal and a receiving device for detecting a sensing signal in an NR system according to an embodiment of the present disclosure.

It is a matter of course that a transmitting device described in FIG. 12 may be a terminal or a base station.

In addition, it is needless to say that a receiving device described in FIG. 12 may be a terminal or a base station.

In operation 1201, the transmitting device generates a sensing code by applying an orthogonal code to a ZC code.

The transmitting device generates a sensing OFDM symbol by performing OFDM conversion on the sensing code generated in operation 1202.

The transmitting device transmits the sensing OFDM symbol generated in operation 1203 through a plurality of antennas.

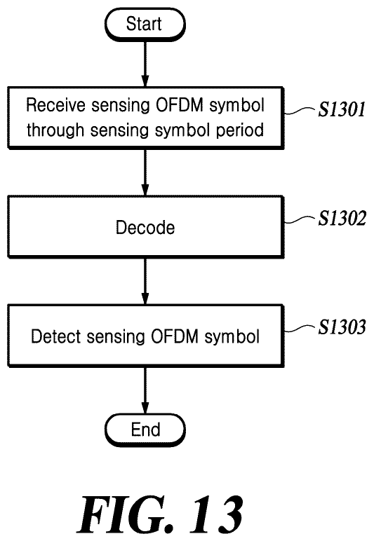

FIG. 13 is a flowchart of a method for receiving a sensing signal in an NR system according to an embodiment of the present disclosure.

It is needless to say that the receiving device described in FIG. 13 may be a terminal or a base station.

The receiving device receives a signal in operation 1301.

The receiving device decodes the signal in operation 1302.

The receiving device detects a sensing OFDM symbol in operation 1303.

The sensing OFDM symbol of step 1303 is detected by the operations of FIG. 5, FIG. 6, FIG. 7, FIG. 9, and FIG. 10 described above. For the sensing OFDM symbol detection operation, refer to the descriptions of FIG. 5, FIG. 6, FIG. 7, FIG. 9, and FIG. 10.

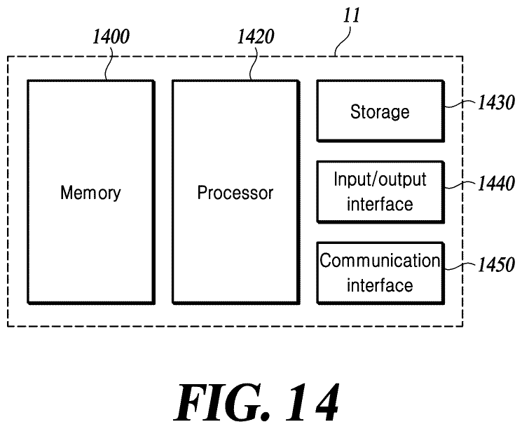

FIG. 14 is a block diagram schematically illustrating an example computing device to which the present disclosure may be applied.

Referring to FIG. 14, a computing device 11 may include some or all of a memory 1400, a processor 1420, a storage 1430, an input/output interface 1440, and a communication interface 1450. The computing device 11 may structurally and/or functionally include at least a part of a transmitting device for generating and transmitting sensing OFDM symbols according to an embodiment of the present disclosure and a receiving device for detecting sensing OFDM symbols in accordance with an embodiment of the disclosure. The computing device 11 may be a stationary computing device, such as a desktop computer, a server, and/or an intelligent camera, as well as a mobile computing device such as a smart phone and/or a laptop computer.

The memory 1400 may store a program for causing the processor 1420 to perform the method(s) according to an embodiment of the present disclosure. For example, the program may include a plurality of instructions executable by the processor 1420, and the plurality of instructions may be executed by the processor 1420 to generate and transmit the sensing OFDM symbol in the transmitting device according to the embodiment of the present disclosure and perform the operations of the apparatus for detecting the sensing OFDM symbols in the receiving device according to the embodiments of the present disclosure.

The memory 1400 may be a single memory or a plurality of memories. The information required for the operation of generating and transmitting the sensing OFDM symbol in the transmitting device according to the embodiment of the present disclosure described above and detecting the sensing OFDM symbols in the receiving device according to the embodiments of the present disclosure may be stored in a single memory or may be separately stored in a plurality of memories. When the memory 1400 is configured with a plurality of memories, the plurality of memories may be physically separated. The memory 1400 may include at least one of a volatile memory and a nonvolatile memory. The volatile memory includes a static random access memory (SRAM), a dynamic random access memory (DRAM), or the like, and the nonvolatile memory includes a flash memory or the like.

The processor 1420 may include at least one core capable of executing at least one instruction. The processor 1420 may be a single processor or a plurality of processors. The processor 1420 may execute instructions stored in the memory 1400.

For example, the processor 1420 is configured to execute the instructions stored in the memory 1400 to: spread a Zadoff-chu (ZC) code sequence into an orthogonal code in a transmitting device to generate a sensing code sequence; perform an orthogonal frequency division multiple access (OFDM) conversion on the sensing code sequence to generate a sensing OFDM symbol; and transmit the sensing OFDM symbol through a plurality of antennas.

The storage 1430 may retain stored data even if power supplied to the computing device 11 is interrupted. For example, the storage 1430 may include a non-volatile memory, and may include a storage medium such as a magnetic tape, an optical disc, or a magnetic disk.

The storage 1430 may store data to be processed by the processor 1420 and data processed by the processor 1420. The program or data stored in the storage 1430 may be loaded into the memory 1400 before being executed by the processor 1420. The storage 1430 may store a file written in a program language, and a program generated by a compiler or the like from the file may be loaded into the memory 1400.

The input/output interface 1440 provides an interface for data input/output with an external device. The input/output interface 1440 may provide an interface with an input device such as a keyboard, mouse, or touch interface, or an output device such as a display. A user may trigger execution of a program by the processor 1420 through an input device, and check a result processed by the processor 1420 through an output device.

The communication interface 1450 provides access to an external network.

At least some of the components described in the exemplary embodiments of the present disclosure may be implemented as hardware elements including at least one or a combination of a digital signal processor (DSP), a processor, a network control unit, an application-specific IC (ASIC), a programmable logic device (FPGA, etc.), and other electronic devices. In addition, at least some functions or processes described in the exemplary embodiments may be implemented by software, and the software may be stored in a recording medium. At least some of the components, functions, and processes described in the exemplary embodiments of the present disclosure may be implemented by a combination of hardware and software.

The method according to the exemplary embodiments of the present disclosure may be written as a computer-executable program, and may also be implemented as various recording media such as a magnetic storage medium, an optical reading medium, and a digital storage medium.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, for example, in a machine-readable storage device (computer-readable medium) or in a propagated signal, for processing by, or to control the operation of, data processing apparatus, e.g., a programmable processor, a computer, or a plurality of computers. A computer program, such as the computer program(s) described above, may be written in any form of programming language, including compiled or interpreted languages, and it may be deployed in any form, including as a stand-alone program or as a module, component, subroutine, or other unit suitable for use in a computing environment. A computer program may be deployed to be processed on one computer or on a plurality of computers at one site or distributed across a plurality of sites and interconnected by a communication network.

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer will include, or be coupled to receive data from or transmit data to, or both, one or more mass storage devices for storing data, e.g., magnetic, magneto-optical disks, or optical disks. Information carriers suitable for embodying computer program instructions and data include, by way of example, semiconductor memory devices, magnetic media such as hard disks, floppy disks, and magnetic tape, optical media such as Compact Disk Read Only Memory (CD-ROMs), Digital Video Disks (DVDs), Magneto-Optical Media such as Floptical Disks, Read Only Memory (ROMs), Random Access Memory (RAMs), flash memory, Erasable Programmable ROM (EPROM), Electrically Erasable Programmeable ROM (EEPROM), and the like. The processor and the memory may be supplemented by, or incorporated in, special purpose logic circuitry.

The processor may execute an operating system and a software application executed on the operating system. Further, the processor device may access, store, manipulate, process, and generate data in response to execution of the software. For ease of understanding, it may be described that one processor device is used, but a person skilled in the art may know that the processor device may include a plurality of processing elements and/or a plurality of types of processing elements. For example, the processor device may include a plurality of processors or one processor and one network control unit. Other processing configurations, such as parallel processors, are also possible.

Moreover, non-transitory computer-readable media may be any available media that may be accessed by a computer and includes both computer storage media and transmission media.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in a plurality of embodiments separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain cases, multitasking and parallel processing may be advantageous. Moreover, the separation of various device components in the embodiments described above should not be understood as requiring such separation in all embodiments, and it should be understood that the described program components and devices may generally be integrated together in a single software product or packaged into a plurality of software products.

It should be noted that the embodiments of the present disclosure disclosed in the specification and the drawings are merely specific examples for facilitating understanding, and are not intended to limit the scope of the present disclosure. It is obvious to a person skilled in the art that other variations based on the technical idea of the present invention may be implemented in addition to the embodiments disclosed herein.

The protection scope of the present embodiment is to be construed according to the following claims, and all technical ideas falling within the scope equivalent thereto are construed as being included in the scope of rights of the present embodiment.

What is claimed is:

1. A method for transmitting and receiving a sensing signal in a new radio (NR) system, comprising:
spreading a Zadoff-chu (ZC) code sequence into an orthogonal code in a transmitting device to generate a sensing code sequence;
generating a sensing OFDM symbol by performing an OFDM (Orthogonal Frequency Division Multiplexing) transform on the sensing code sequence; and
transmitting a communication symbol and the sensing OFDM symbol through a plurality of antennas,
wherein each of the communication symbol and the sensing OFDM symbol is added with a cyclic prefix (CP), and
wherein the communication symbol is configured to be followed by two of the sensing OFDM symbols.

2. The method of claim 1,
wherein the spreading a ZC code sequence into an orthogonal code to generate a sensing code sequence comprises:
spreading the ZC code sequence into the orthogonal code in terms of frequency and time.

3. The method of claim 1,
wherein the orthogonal code comprises:
one of a Walsh Hadamard code and a Discrete Fourier Tranform (DFT) code.

4. The method of claim 1,
wherein the length of the orthogonal code and the number of the orthogonal codes are the same.

5. The method of claim 1,
wherein the transmitting the sensing OFDM symbol through a plurality of antennas comprises:
notifying a position at which the sensing OFDM symbol is transmitted in a specific slot by a predetermined offset, a predetermined period, and a predetermined section.

6. The method of claim 5,
wherein the offset, the period, and the section are transmitted through a Radio Resource Control (RRC) message.

7. The method of claim 1,
wherein the transmitting the sensing OFDM symbol through a plurality of antennas comprises:
notifying transmission and interruption of the sensing OFDM symbol through a Medium Access Control Control Element (MAC CE).

8. The method of claim 1,
wherein the transmitting the sensing OFDM symbol through a plurality of antennas comprises:
notifying transmission of a one-time sensing OFDM symbol through a Physical Downlink Control Channel (PDCCH) Downlink Control Information (DCI).

9. The method of claim 1,
wherein the transmitting the sensing OFDM symbol through a plurality of antennas is such that the sensing OFDM symbol is not transmitted during a section in which a sensing OFDM symbol of another base station is transmitted.

10. The method of claim 1,
wherein a receiving device receives the communication symbol and the sensing OFDM symbol, and when detecting a predetermined sample delayed signal in an echo symbol, removes first samples located at the last part of a last sensing OFDM symbol detection period, copies second samples located at the last part in a CP period of the last sensing OFDM symbol detection period to generate samples corresponding to an FFT length, and outputs a sensing sequence received by performing FFT on samples corresponding to the FFT length.

11. The method of claim 1,
wherein a receiving device receives the communication symbol and the sensing OFDM symbol, and when detecting a predetermined sample delayed signal in an echo symbol, removes third samples located at a last part of a detection period of a last sensing OFDM symbol to generate samples corresponding to an FFT length, and outputs a sensing sequence received by applying correlation to the samples corresponding to the FFT length.

12. The method of claim 1, further comprising:
repeatedly transmitting the communication symbol and the sensing OFDM symbol, and adding a cyclic postfix (CP₀) to a remaining period before a next communication symbols starts.

13. The method of claim 12,
wherein a receiving device receives the communication symbol and the sensing OFDM symbol, and when detecting a predetermined sample delayed signal in an echo symbol, generates samples corresponding to an FFT length by reflecting fifth samples in a cyclic postfix (CP₀) section without reflecting fourth samples in a CP section located in a last sensing OFDM symbol detection section, and outputs a sensing sequence received by applying correlation to the samples corresponding to the FFT length.

14. An apparatus for transmitting and receiving a sensing signal in a new radio (NR) system, comprising:
a memory including instructions; and
a processor configured to, in a transmitting device by executing the instruction, spread a Zadoff-chu (ZC) code sequence into an orthogonal code to generate a sensing code sequence, generate a sensing OFDM symbol by performing an OFDM (Orthogonal Frequency Division Multiplexing) transform on the sensing code sequence and transmit a communication symbol and the sensing OFDM symbol through a plurality of antennas;
wherein a cyclic prefix (CP) is added to each of the communication symbol and the sensing OFDM symbol; and
the communication symbol is configured to be followed by two of the sensing OFDM symbols.

15. The apparatus of claim 14,
wherein the length of the orthogonal code and the number of the orthagonal codes are the same.

16. The apparatus of claim 14,
wherein the processor is configured to notify a position at which the sensing OFDM symbol is transmitted in a specific slot by a predetermined offset, period, and section.

17. The apparatus of claim 16,
wherein the offset, the period, and the section are transmitted through a Radio Resource Control (RRC) message.

18. The apparatus of claim 14,
wherein the processor is configured to notify transmission and interruption of the sensing OFDM symbol through a Medium Access Control Control Element (MAC CE).

19. The apparatus of claim 14,
wherein the processor is configured to notify transmission of a one-time sensing OFDM symbol through a Physical Downlink Control Channel (PDCCH) Downlink Control Information (DCI).

20. The apparatus of claim 14,
wherein the processor is configured not to transmit the sensing OFDM symbol during a section in which the sensing OFDM symbols of another base station are transmitted.
